(19) United States
(12) Patent Application Publication
(10) Pub. No.: US 2009/0021099 A1
(43) Pub. Date: Jan. 22, 2009

(54) Pulsed Inertial Electric Motor

(75) Inventor: Vasily Vasilievich Shkondin, Moscow (RU)

Correspondence Address: Pearl Cohen Zedek Latzer, LLP, 1500 Broadway, 12th Floor, New York, NY, 10036, US

(73) Assignee: PULSED INERTIAL ELECTRIC MOTOR

(21) Appl. No.: 11/918,039

(22) PCT Filed: Jan. 10, 2006
(86) PCT No.: PCT/GB2006/001295

§ 371 Date: Oct. 9, 2007

(30) Foreign Application Priority Data
Apr. 11, 2005 (RU) 2005110334
Jan. 20, 2006 (IN) 160/DEL/2006

(51) Int. Cl. H02K 3/28

(52) U.S. Cl. 310/203

(57) ABSTRACT

A pulsed inertial electric motor of the present invention comprises (i) a stator with an annular magnetic conductor on which an even number of permanent magnets are uniformly arranged with a predetermined pitch, (ii) a rotor separated from the stator by an air gap and bearing an even number of electromagnets, each electromagnet consisting of first and second coils with mutually opposed winding directions, the coils being connected in series, (iii) a collector distributor (commutator) mounted on the stator body, containing current-conducting plates separated by insulating spacers and connected with alternating polarity to a direct current (DC) source, and (iv) current collectors mounted on the rotor and capable of contacting with plates of the collector distributor

### FIELD OF THE INVENTION

The present invention relates to electric motors, in particular to low-voltage gearless commutator motors, and can be used as motor-wheels in vehicles such as electrically propelled bicycles, scooters, motorcycles, electric-motor cars, etc., as well as in other technologies.

### BACKGROUND OF THE INVENTION

Devices and machines provided with a reduction gear and an asynchronous electric motor are widely used in various technologies, in particular, in transportation. Asynchronous motors, being ecologically safe, reliable, and economically effective, offer a number of advantages over internal combustion engines.

The best prospects are related to a gearless (direct-drive) motor-in-wheel (motor-wheel) in which the wheel rotation is induced directly by the electromagnetic interaction between the built-in rotor and stator magnetic systems. In the prior art, there is known a motor-wheel comprising a rim and a shaft with a built-in asynchronous electric motor. The motor represents a disk asynchronous electric machine comprising a stator with a magnetic conductor, windings, and a current lead, which is mounted on an immobile axis, and a rotor with short-circuit winding and magnetic conductors situated on both sides of the stator. The stator and rotor in assembly comprise a wheel capable of spinning. This motor-wheel design provides high reliability due to the absence of a mechanical reduction gear and is characterized by better cooling conditions as compared to the traditional design, which is ensured by radial channels carrying a cooling medium. However, use of this asynchronous electric motor still leads to high heat evolution and requires a complicated control system and high-voltage power supply. Such a motor-wheel offers no prospects of electric energy recuperation during braking of the vehicle.

Another built-in motor known in the prior art comprises two main parts: an immobile stator, mounted on the axis and provided with a magnetic conductor and a set of uniformly arranged permanent magnets, and a mobile rotor bearing a rim and containing at least two groups of electromagnets. A collector distributor (commutator) is mounted on the stator and provided with current-conducting plates connected to a direct current (DC) source. The rotor bears current collectors that make electrical contact with plates of the collector distributor.

This motor-wheel can be implemented in several modifications and variants. Advantages of this design are the absence of a reducing gear, use of low-voltage power sources, absence of supplementary electronic circuits, possibility of energy recuperation, and small size and weight. By combining the main elements of this motor-wheel with auxiliary elements, it is possible to create a variety of analogous devices retaining all advantages of said motor-wheel.

However, the above motor-wheel and its analogues still have some disadvantages, the main of these being large start and transient currents in the course of starting and accelerating the vehicle. This leads to rapid degradation and a decrease in the working life of storage batteries and to unfavourable thermal regimes. Another drawback is low efficiency of recovery and use of electric energy. Finally, said electric motors are characterized by relatively low torque, which considerably reduces the field of possible practical applications. Technical solutions suggested to eliminate these disadvantages are based on the use of high-voltage power sources and complicated control schemes, which increase the cost and decrease reliability of such systems in exploitation.

### SUMMARY OF THE INVENTION

The aim of embodiments of the present invention is to provide an electric motor with increased performance characteristics, relatively simple design, and high reliability. A pulsed inertial electric motor of the present invention comprises (i) a stator with an annular magnetic conductor on which an even number of permanent magnets are uniformly arranged with a predetermined pitch, (ii) a rotor separated from the stator by an air gap and bearing an even number of electromagnets, each electromagnet consisting of first and second coils with mutually opposed winding directions, the coils being connected in series, (iii) a collector distributor (commutator) mounted on the stator body, containing current-conducting plates separated by insulating spacers and connected with alternating polarity to a direct current (DC) source, and (iv) current collectors mounted on the rotor and capable of contacting with plates of the collector distributor.

More specifically, according to the present invention, there is provided a pulsed inertial electric motor, comprising:
(i) a stator with an annular magnetic conductor on which an even number of permanent magnets are uniformly arranged with a predetermined pitch, with adjacent permanent magnets being of alternating polarity;
(ii) a rotor separated from the stator by air gap and being coaxial therewith about an axis, the rotor bearing an even number of electromagnets arranged pairwise in diametrically opposed relationship about the axis, each electromagnet consisting of first and second coils with opposite winding directions, which coils are connected in series
(iii) a current distributor mounted on the stator, and bearing circularly arranged current-conducting plates separated by insulating spacers and connected with alternating polarity to a dc current source; and
(iv) current collectors mounted on the rotor and capable of contacting the plates of the current distributor, wherein each current collector is connected to the first coil of a respective electromagnet and also to the first coil of the electromagnet opposed to the respective electromagnet, wherein the second coil of each electromagnet is connected to the second coil of its opposing electromagnet, wherein the coils of adjacent electromagnets are connected in series, and wherein the number n of permanent magnets on the stator obeys the relation n=10+4 k, where k is an arbitrary integer (k=0, 1,2, 3, . . . ).

Each electromagnet comprises first and second coils having mutually opposed winding directions, with a terminal being provided on each first coil for connection to one of the current collectors. In other words, the current collectors are connected in each case to the first coil of each electromagnet. The current collectors may take the form of brushes.

Moreover, the first and second coils of each electromagnet are connected in series, with adjacent electromagnets also being connected in series by way of a connection from the second coil of one electromagnet to the first coil of the adjacent electromagnet.

The electromagnets are arranged such that each pair of coils is disposed in a diametrically opposed relationship to another pair of coils.

Each coil may be provided with at least one terminal for its various electrical connections.

The number (n) of permanent magnets in the stator and the number (m) of electromagnets in the rotor are preferably selected so as to obey the relations:
i) n=10+4 k,
   where k is an arbitrary integer (k=0, 1, 2, . . . ), and
ii) m=4+2I,
   where I is any integer such that 0≦I≦k. The numbers of permanent magnets and electromagnets are most frequently selected as follows: n=10, m=4; n=14, m=6; n=18, m=4; n=22, m=4, 6, 8, 10; n=26, m=4, 6, 8, 10, 12, and so on. For the proposed arrangement of magnets and the adopted scheme of commutation, these relations provide for a resonance of currents in the coils of opposite electromagnets, which decreases the voltage jumps in the start-up and acceleration regimes and improves the dynamic characteristics of the motor. In addition, this scheme ensures a maximum, or at least improved, recuperation of electric energy due to counter-emf development when free-running.

In one preferred embodiment, the first coil of each electromagnet is connected to the current collector of its opposing electromagnet by way of a shunt including at least one capacitor so as to form resonant circuits. This additionally improves the dynamic characteristics of the motor and helps to reduce or eliminate sparking at the current collector brushes. The capacitance of such shunting capacitors may be increased in proportion to the number of turns in the coils of the electromagnets. It is also desirable that all resonant circuits formed by these capacitors and coils have the same resonance frequency. However, it is to be appreciated that this shunting arrangement is not an essential feature.

Sparking at the current collector brushes can also be reduced or eliminated by selecting an appropriate phase lead in the contact between the brushes and the current-conducting collector plates. In order to provide for this, the brushes are usually mounted so as to make possible a control of their positions relative to the plates. The optimum phase lead falls within 0-8°.

The total number of turns in coils of the opposing electromagnets may be different. The resonance phenomena are increased provided that this difference amounts to ½^{p} of the total number of turns in one of the coils, where p=2, 3, 4 . . . and so forth.

The present invention can be implemented in both unidirectional and reversible variants, depending on the regime of the electric power supply. In the former case, the positive current-carrying plates of the current distributor are connected to the positive electrode of the dc current source, while the negative current-carrying plates are shorted to the motor frame. In the reversible embodiment, the positive plates of the current distributor are also connected to the positive electrode of the power supply source, but the negative plates are connected to the negative electrode of the dc current source and isolated from the motor case. In order to change the direction of rotation, it is necessary to switch the mode of collector plate connection to the power supply electrodes.

The number of current-conducting plates on the current distributor is preferably equal to the number of permanent magnets on the stator.

The insulating spacers of the collector distributor are advantageously radially aligned with the permanent magnets of the stator.

The motor according to the present invention can be implemented so that the rotor is arranged either outside or inside the stator.

Throughout the description and claims of this specification, the words “comprise” and “contain” and variations of the words, for example “comprising” and “comprises”, means “including but not limited to”, and is not intended to (and does not) exclude other moieties, additives, components, integers or steps.

Throughout the description and claims of this specification, the singular encompasses the plural unless the context otherwise requires. In particular, where the indefinite article is used, the specification is to be understood as contemplating plurality as well as singularity, unless the context requires otherwise.

Features, integers, characteristics, compounds, chemical moieties or groups described in conjunction with a particular aspect, embodiment or example of the invention are to be understood to be applicable to any other aspect, embodiment or example described herein unless incompatible therewith.

### BRIEF DESCRIPTION OF THE DRAWINGS

For a better understanding of the present invention and to show how it may be carried into effect, reference shall now be made by way of example to the following drawings, in which:

FIG. 1 is a schematic diagram of a motor of an embodiment of the present invention, in which the stator is arranged inside the rotor;

FIG. 2 is a diagram showing connections for a reversible motor of an embodiment of the present invention;

FIG. 3 shows the typical time series of voltage pulses arising in a resonance circuit during operation of a motor embodying the present invention; and

FIG. 4 is a schematic diagram of a motor of an embodiment of the present invention, in which the rotor is arranged inside the stator.

### DETAILED DESCRIPTION OF THE INVENTION

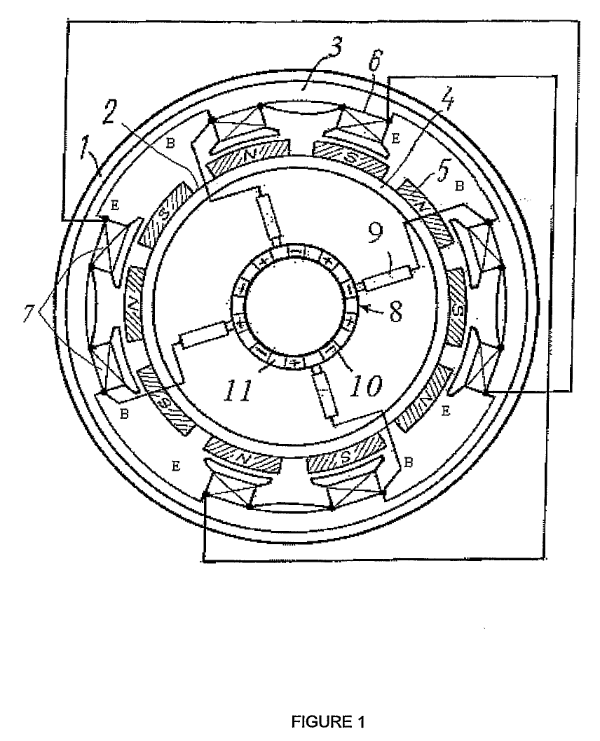

FIG. 1 shows a schematic diagram of a pulsed inertial motor of an embodiment of the present invention, which can be used as a motor-wheel in various vehicles, for example, in electrically propelled bicycles. The electric motor has a frame (1), which also plays the role of a protective shell and transfers rotation to the wheel. The frame is connected by spokes to a rim (not depicted in the figure). The main parts of the motor are a stator (2) arranged inside a rotor (3). The stator has a circular magnetic conductor (4) bearing an even number of permanent magnets (5) arranged at equal pitch and alternating polarity (in this particular case, there are ten permanent magnets). The rotor (3) is separated from the stator (2) by an air gap and bears an even number (in this particular case, four) of electromagnets (6) arranged in pairs one opposite to another (two pairs). Each electromagnet consists of two coils (7) with opposite winding directions (clockwise against anticlockwise), which are connected in series, so that the end (denoted by “E” in FIG. 1) of the second coil in each electromagnet is connected to the beginning (denoted by “B” in FIG. 1) of the first coil of the adjacent electromagnet.

In the course of operation, the coils (7) of electromagnets (6) are supplied with power from a dc current source (not depicted in FIG. 1) via a current collector distributor (8) and brushes (9). The collector distributor (commutator) is mounted on the stator body, while the brushes (9) are mounted on the rotor and move with the rotor relative to the current-carrying plates (10) of the collector distributor (8), and are capable of contacting with these plates. The collector distributor plates (10) are separated by insulating gaps (11) and connected in series with alternating polarity to the dc current source. The number of the collector distributor plates (in the given case, ten) is equal to the number of permanent magnets in the stator.

All brushes (9) are connected to identical terminals of electromagnets (6). In FIG. 1, each brush is connected to the beginning (B) of the first coil of the corresponding electromagnet (it is also possible to connect brushes to the ends (E) of the second coils; in which case the motor will rotate in the opposite direction).

The coils of adjacent electromagnets (6) are connected to each other in series, whereby the end (E) of one electromagnet is connected to the beginning (B) of the adjacent electromagnet, and the terminals not connected to brushes are connected to identical terminals of the corresponding coil of the opposite electromagnet.

The number (n) of permanent magnets in the stator (in FIG. 1, n=10) and the number (m) of electromagnets in the rotor (in FIG. 1, m=4) are selected so as to obey the relations:
i) n=10+4 k, and
ii) m=4+2I,
where k is an arbitrary integer (k =0, 1, 2, . . . ) and I is any integer such that 0≦I≦k (in FIG. 1, k=I=0).

The principle of operation of the electric motor according to the present invention is analogous to that of the traditional dc motor and is based on the electromagnetic forces of mutual attraction and repulsion arising during the interaction of electromagnets (6) of the rotor with permanent magnets (5) of the stator. When an electromagnet occurs in a position with its axis situated between the axes of two neighbouring permanent magnets, the coils of this electromagnet are powered so that the resulting magnetic pole is opposite to the pole of the subsequent permanent magnet and coincides with that of the previous permanent magnet. Thus, the given electromagnet is simultaneously subjected to repulsion from the previous permanent magnet and attraction to the subsequent permanent magnet. When the axes of the electromagnet and permanent magnet coincide, the electromagnet is not connected to the dc current source because the brush passes over an insulating spacer between conducting plates. This position is traversed by inertia. Advantages of the proposed motor are provided by a certain strictly determined ratio of the numbers of electromagnets and permanent magnets, their mutual arrangement, and the scheme of commutation.

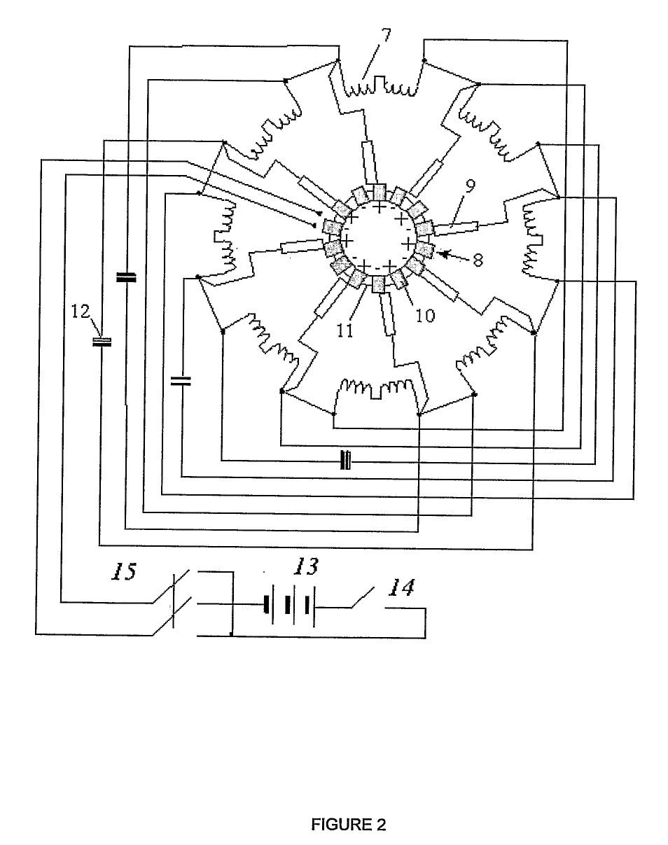

FIG. 2 shows the typical electric wiring diagram of a motor according to the present invention. Here, the number of the permanent magnets in the stator (n=14) and the number of electromagnets in the rotor (m=6) are also selected so as to obey the relations n=10+4 k, m=4+2I, where k=I=1.

The terminals of coils of the opposite electromagnets (6) connected to the brushes (8) are shunted by capacitors (11) so as to form resonant circuits. This shunting additionally improves the dynamic characteristics of the motor and practically eliminates sparking at the collector brushes. The capacitance of these shunting capacitors is increased in proportion to the number of turns in the coils. The total number of turns in the coils of the opposite electromagnets may be different. In order to increase the resonance phenomena, it is necessary to provide that this difference would amount to ½^{p} of the total number of turns in a coil (where p=2, 3, 4, . . . ). For example, if the total number of turns in the coils of one electromagnet is 128 and p=5, the total number of turns in coils of the opposite electromagnet is 124; for p=4, the total number of turns in coils of the opposite electromagnet is 120, and so on.

The collector distributor (8) is connected to a dc current source (13) via a common switch (14). The scheme may also include an additional switch (15) alternating the polarity of the voltage applied to the collector distributor. This switch changes the direction of motor rotation from forward to reverse. In addition, the scheme may involve additional units (not depicted in FIG. 2) providing stabilization and control over the electric current. For example, start-up and acceleration regimes can be facilitated by using a highly reliable chemotronic accumulator providing a high-power pulse discharge.

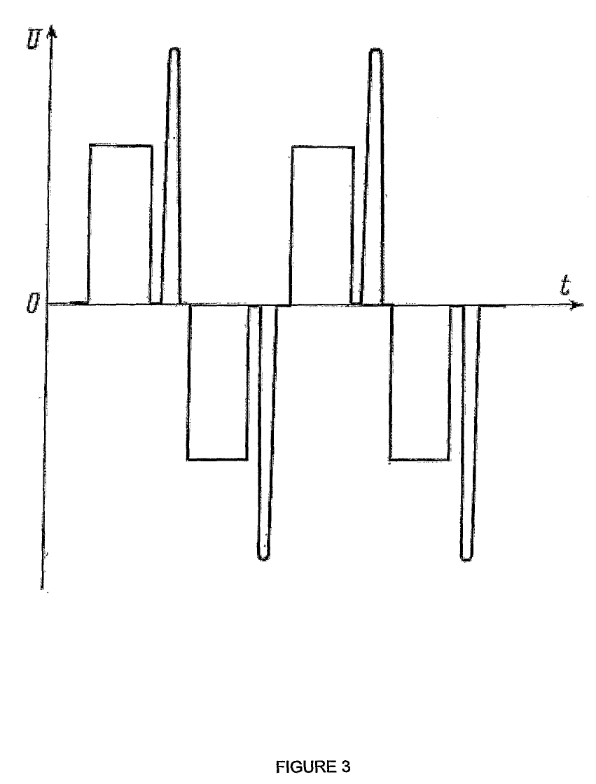

FIG. 3 presents the typical time series of voltage pulses arising in a resonance circuit formed by electromagnet coils and the corresponding shunting capacitors. A change in the polarity of connection of each circuit in the course of rotation creates alternating current in the circuits. A torque developed by the motor is enhanced due to a resonance increase in this current.

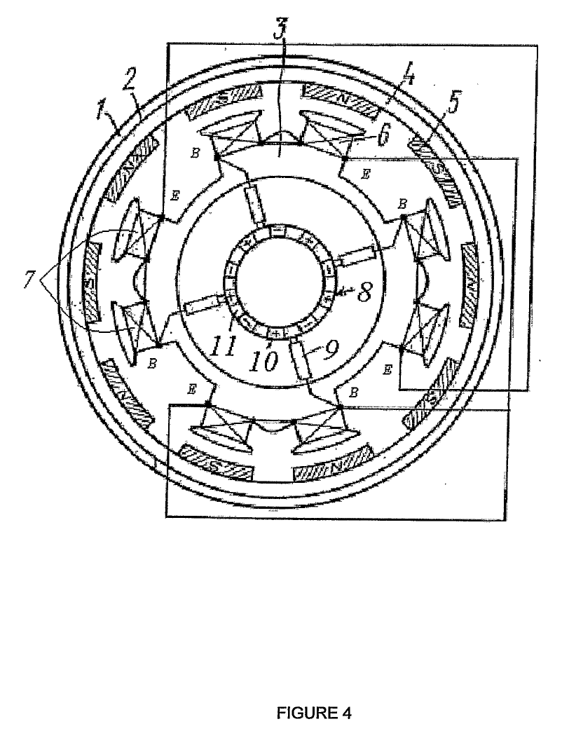

FIG. 4 shows a schematic diagram of the motor according to the present invention, in which the stator (2) is arranged outside the rotor (3). This variant can be used, for example, in electric elevators, generators, etc. Otherwise, the design and principle of operation of this motor are analogous to those described above.

### EXAMPLES

Electric motors according to the present invention show evidence for reliable design and exhibit high performance characteristics.

### Example 1

A prototype electric motor was constructed with a stator having 22 permanent magnets, a rotor having three pairs of electromagnets, and the coils in each electromagnet containing 68 turns of a 1.06 mm diameter wire. The motor had the following parameters: diameter 300 mm; width 50 mm; weight 7.5 kg; power consumption 240 W; supply voltage 24V; torque 9.6 N/m.

This motor was used as a motor-wheel in a bicycle of the STELS type with 26″ (66 cm) wheels. The current source comprised a pair of 12V storage batteries, each with a capacity of 20 A/h. The bicycle with an electric drive based on the proposed motor was tested to show the following characteristics: weight-carrying capacity 120 kg; cruising speed 25 km/h; maximum run (for a storage battery discharged to 10.5V) 40 km.

### Example 2

A prototype electric motor was constructed with a stator having 22 permanent magnets, a rotor having five pairs of electromagnets, and the coils in each electromagnet containing 50 turns of a 1.25 mm diameter wire. The motor had the following parameters: diameter 300 mm; width 60 mm; weight 9.6 kg; power consumption 1000 W; supply voltage 48V; torque 40 N/m.

This motor was used as a motor-wheel in a scooter type with 16″ (40 cm) motorcycle wheels. The current source comprised four 12V storage batteries, each with a capacity of 20 A/h. The scooter with an electric drive based on the proposed motor was tested to show the following characteristics: weight-carrying capacity 150 kg; cruising speed 45 km/h; maximum speed 60 km/h; maximum run (for a storage battery discharged to 10.5V) 50 km.

### Example 3

A prototype electric motor was constructed with a stator having 18 permanent magnets, a rotor having four pairs of electromagnets, and the coils in each electromagnet containing 55 turns of a 1.32 mm diameter wire. The motor had the following parameters: diameter 306 mm; width 72 mm; weight 11 kg; power consumption 1500 W; supply voltage 48V; torque 52 N/m.

Two such motors were used as motor-wheels in a three-wheel carriage with 16″ (40 cm) motorcycle wheels for a driver and two passengers. The current source comprised four 12V storage batteries, each with a capacity of 60 A/h. The carriage with an electric drive based on the proposed motor was tested to show the following characteristics: weight-carrying capacity 500 kg; cruising speed 45 km/h; maximum speed 70 km/h; maximum run (for a storage battery discharged to 10.5V) 70 km.

1. A pulsed inertial electric motor, comprising:
(i) a stator with an annular magnetic conductor on which an even number of permanent magnets are uniformly arranged with a predetermined pitch, with adjacent permanent magnets being of alternating polarity;
(ii) a rotor separated from the stator by air gap and being coaxial therewith about an axis, the rotor bearing an even number of electromagnets arranged pairwise in diametrically opposed relationship about the axis, each electromagnet consisting of first and second coils with opposite winding directions, which coils are connected in series;
(iii) a current distributor mounted on the stator, and bearing circularly arranged current-conducting plates separated by insulating spacers and connected with alternating polarity to a dc current source; and
(iv) current collectors mounted on the rotor and capable of contacting the plates of the current distributor, wherein each current collector is connected to the first coil of a respective electromagnet and also to the first coil of the electromagnet opposed to the respective electromagnet, wherein the second coil of each electromagnet is connected to the second coil of its opposing electromagnet, wherein the coils of adjacent electromagnets are connected in series, and wherein the number n of permanent magnets on the stator obeys the relation n=10+4 k, where k is an arbitrary integer.

2. An electric motor as claimed in claim 1, wherein the number m of electromagnets in the rotor obeys the relation m=4+2l, where l is any integer such that 0≦l≦k.

3. An electric motor as claimed in claim 1, wherein the number of current-conducting plates on the current distributor is equal to the number of permanent magnets on the stator.

4. An electric motor as claimed in claim 1, wherein the insulating spacers of the collector distributor are radially aligned with the permanent magnets of the stator.

5. An electric motor as claimed in claim 1, wherein the total numbers of turns in the coils of opposed electromagnets are different, wherein this difference amounts to ½^{p} of the total number of turns in one of the coils, where p is an integer not less than 2.

6. An electric motor as claimed in claim 1, further comprising a dc power source having positive and negative terminals, and a motor frame or case, wherein positive current-conducting plates of the current distributor are connected to the positive terminal of the power source, and negative current-carrying plates are shorted to the motor frame or case.

7. An electric motor as claimed in claim 1, further comprising a dc power source having positive and negative terminals, and a motor frame or case, wherein positive current-conducting plates of the current distributor are connected to the positive terminal of the power source, and wherein negative plates of the current distributor are connected to the negative terminal of the power source and are isolated from the motor frame or case.

8. An electric motor as claimed in claim 2, wherein a phase lead in the contact between the current collectors and the current-conducting plates is from 0-8°.

9. An electric motor as claimed in claim 1, wherein the rotor is arranged outside the stator.

10. An electric motor as claimed in claim 1, wherein the rotor is arranged inside the stator.

11. An electric motor as claimed in claim 1, wherein the connection between each current collector and the first coil of the opposed electromagnet is provided with a shunting capacitor so as to form a resonant circuit.

12. An electric motor as claimed in claim 11, wherein the capacitance of said capacitors is proportional to a number of turns of the coils of electromagnets.

13. An electric motor as claimed in claim 11, wherein the resonant circuits formed by said capacitors and coils all have the same resonance frequency.

14. (canceled)
